(19) United States
(12) Patent Application Publication
(10) Pub. No.: US 2023/0052810 A1
(43) Pub. Date: Feb. 16, 2023

(54) CONTROL APPARATUS, CONTROL SYSTEM, AND METHOD FOR DETERMINING FUNCTION OR OPERATION OF CONTROL APPARATUS

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Masahiro ENDO, Yokkaichi-shi, Mie (JP)

(21) Appl. No.: 17/759,253

(22) PCT Filed: Jan. 15, 2021
(86) PCT No.: PCT/JP2021/001146

§ 371 Date: Jul. 21, 2022

(30) Foreign Application Priority Data
Jan. 24, 2020 (JP) 2020-010238

(51) Int. Cl. G05B 15/02

(52) U.S. Cl. CPC G05B 15/02

(57) ABSTRACT

The present disclosure provides a control apparatus, a control system, and a method for determining a function or operation of the control apparatus, according to which the manufacturing cost can be reduced. A control apparatus including: a storage unit configured to store associated information in which a designator that designates a function or operation of a control apparatus and a data identifier that identifies a transmission source device that is a transmission source of data are associated with each other for each of a plurality of designators; a receiving unit configured to receive the data identifier from the transmission source device via a communication line; and a control unit, wherein the control unit determines a designator for the control apparatus based on the data identifier received by the receiving unit and the associated information.

### CROSS-REFERENCE TO RELATED APPLICATIONS

This application is the U.S. national stage of PCT/JP2021/001146 filed on Jan. 15, 2021, which claims priority of Japanese Patent Application No. JP 2020-010238 filed on Jan. 24, 2020, the contents of which are incorporated herein.

### TECHNICAL FIELD

The present disclosure relates to a control apparatus, a control system, and a method for determining a function or operation of the control apparatus.

### BACKGROUND

Following recent advances in electronic technology, many ECUs (Electronic Control Units) that control various in-vehicle components such as engines, batteries, doors, lamps, wipers, and air conditioners have come to be mounted in vehicles. The ECUs include a CPU, a memory, an input/output interface, and the like, and transmit/receive information with each other via an in-vehicle LAN such as CAN or Ethernet (registered trademark).

JP 2018-188146A discloses a vehicle system provided with a plurality of vehicle modules that have been modularized according to the assembled structure of a vehicle, and each vehicle module is provided with a vehicle module control apparatus (ECU).

The ECUs disclosed in JP 2018-188146A are disposed according to the assembled structure of a vehicle, and the ECUs have different functions or perform different operations. Thus, each ECU needs to be manufactured individually, which increases the manufacturing cost.

### SUMMARY

Thus, it is an object of the present disclosure to provide a control apparatus, a control system, and a method for determining a function or operation of the control apparatus, according to which the manufacturing cost can be reduced.

A control apparatus according to the present disclosure, including: a storage unit configured to store associated information in which a designator that designates a function or operation of a control apparatus and a data identifier that identifies a transmission source device that is a transmission source of data are associated with each other for each of a plurality of designators; a receiving unit configured to receive the data identifier from the transmission source device via a communication line; and a control unit, wherein the control unit determines a designator for the control apparatus based on the data identifier received by the receiving unit and the associated information.

A control system according to the present disclosure, including: a plurality of control apparatuses that perform different functions or operations; and a central control apparatus that is connected to the plurality of control apparatuses via communication lines.

A method for determining a function or operation of the control apparatus of the present disclosure, the method including: storing associated information in which a designator that designates a function or operation of a control apparatus and a data identifier that identifies a transmission source device of data are associated with each other for each of a plurality of designators; receiving the data identifier from the transmission source device via a communication line; and determining a designator based on the received data identifier and the associated information.

### ADVANTAGEOUS EFFECTS OF PRESENT DISCLOSURE

With the present disclosure, the manufacturing cost can be reduced.

### BRIEF DESCRIPTION OF DRAWINGS

FIG. 1 is a schematic diagram showing an example of a configuration of a control system of the present embodiment.

FIG. 2 is a block diagram showing an example of a configuration of a central ECU.

FIG. 3 is a block diagram showing an example of a configuration of a zone ECU.

FIG. 4 is a schematic diagram showing an example of associated information.

FIG. 5 is a schematic diagram showing an example of a method for determining a function or operation of the zone ECU.

FIG. 6 is a schematic diagram showing an example of processing performed when a function or operation of the zone ECU cannot be determined.

FIG. 7 is a schematic diagram showing an example of a method performed by a central ECU for determining a function or operation of a zone ECU.

FIG. 8 is a schematic diagram showing an example of a method for updating associated information.

FIG. 9 is a flow chart showing an example of a processing procedure performed by a control system of the present embodiment.

### DETAILED DESCRIPTION OF PREFERRED EMBODIMENTS

First, embodiments of the present disclosure will be listed and described below. Furthermore, the embodiments described below may at least be partially combined as appropriate.

A control apparatus according to the present embodiment, including: a storage unit configured to store associated information in which a designator that designates a function or operation of a control apparatus and a data identifier that identifies a transmission source device that is a transmission source of data are associated with each other for each of a plurality of designators; a receiving unit configured to receive the data identifier from the transmission source device via a communication line; and a control unit, wherein the control unit determines a designator for the control apparatus based on the data identifier received by the receiving unit and the associated information.

A control system according to the present embodiment, including: a plurality of control apparatuses that perform different functions or operations; and a central control apparatus that is connected to the plurality of control apparatuses via communication lines.

A method for determining a function or operation of the control apparatus of the present embodiment, the method including: storing associated information in which a designator that designates a function or operation of a control apparatus and a data identifier that identifies a transmission source device of data are associated with each other for each of a plurality of designators; receiving the data identifier from the transmission source device via a communication line; and determining a designator based on the received data identifier and the associated information.

The storage unit stores associated information in which a designator that designates the function or operation of the control apparatus and a data identifier that identifies the transmission source device of data are associated with each other for each of a plurality of designators. The same associated information is stored in advance in the storage unit of each control apparatus mounted in a vehicle. For example, assuming that four control apparatuses are mounted in a vehicle, the function or operation of each control apparatus is indicated as A, B, C, or D, and the designators that designate the functions or operations A, B, C, and D are indicated as AAA, BBB, CCC, or DDD. Also, it is assumed that the data identifiers of transmission source devices that perform data communication with the control apparatus whose function or operation is A are indicated as #100 and #150, and similarly, the data identifiers corresponding to the control apparatus whose function or operation is B are indicated as #170 and #200, the data identifiers corresponding to the control apparatus whose function or operation is C is indicated are indicated as #250 and #300, and the data identifier corresponding to the control apparatus whose function or operation is D is indicated as #350.

The receiving unit receives a data identifier from a transmission source device via a communication line. In the manufacturing stage or the assembly stage in which common-use control apparatuses are installed in the vehicle, the initiation of data transmission from each transmission source device results in the corresponding receiving units being able to receive a data identifier.

The control unit determines a designator for the same control apparatus based on a data identifier received by the receiving unit and the associated information. For example, if a certain control apparatus receives the data identifiers #100 and #150, the control apparatus can determine that the function or operation of the control apparatus is the function or operation A designated by the designator AAA, based on associated information stored in the storage unit. The same also applies to other control apparatuses.

In other words, in the manufacturing stage or the assembly stage in which common-use control apparatuses are installed in the vehicle, the function or operation of each control apparatus can be determined. Accordingly, common-use control apparatuses can be manufactured, and the function or operation of each control apparatus can be determined in the manufacturing stage or the assembly stage of the vehicle, and thus there is no need to individually manufacture control apparatuses with different functions or operations in advance, and the manufacturing cost can be reduced.

In the control apparatus according to the present embodiment, the control unit refers to the associated information stored in the storage unit based on the data identifier received by the receiving unit, and determines, as the designator for the control apparatus, a designator associated with a data identifier that matches the received data identifier.

The control unit can refer to the associated information stored in the storage unit based on the data identifier received by the receiving unit, and determine, as the designator for the control apparatus, the designator that is associated with the data identifier that matches the received data identifier.

In the control apparatus according to the present embodiment, the control unit outputs the determined designator to a program providing apparatus, and obtains a program for realizing a function or operation designated by the designator from the program providing apparatus.

The control unit outputs the determined designator to the program providing apparatus. As a result of, for example, the program providing apparatus installing a program corresponding to a certain function or operation in a common-use control apparatus, the common-use control apparatus can be changed to a control apparatus dedicated to the certain function or operation.

The control unit obtains a program for realizing the function or operation designated by the designator from the program providing apparatus. By installing the obtained program, the control apparatus can realize the function or operation designated by the designator. In other words, in the manufacturing stage or the assembly stage of the vehicle, the common-use control apparatuses can be changed to control apparatuses dedicated to certain functions or operations. Note that obtaining a program includes, in addition to obtaining a complete or partial program, obtaining parameters read by a program (for example, a configuration file).

In the control apparatus according to the present embodiment, the control unit executes processing that is based on the obtained program.

The control unit executes processing that is based on the obtained program. Accordingly, each control apparatus mounted in the vehicle can execute not only shared functions or operations, but also unique functions or operations.

In the control apparatus according to the present embodiment, if the data identifier received by the receiving unit is not included in the associated information, the control unit obtains associated information from an associated information providing apparatus, and updates the associated information stored in the storage unit using the obtained associated information.

If a data identifier received by the receiving unit is not included in the associated information, the control unit obtains associated information from the associated information providing apparatus. The associated information providing apparatus can retain the most recent associated information. The control unit updates the associated information stored in the storage unit using the associated information obtained from the associated information providing apparatus.

For example, if the control apparatuses are mounted in the vehicle and a new transmission source device (also including an ECU) is added as an option or through customization, the associated information stored in the storage units may not include information regarding the newly added transmission source device. In such a case, by updating the associated information, the associated information can be updated to the most recent information.

The control apparatus according to the present embodiment, including: a recording unit configured to, if the data identifier received by the receiving unit is not included in the associated information stored in the storage unit, record the data identifier as an error log.

If a data identifier received by the receiving unit is not included in the associated information stored in the storage unit, the recording unit records the data identifier as an error log. If the received data identifier is not included in the associated information stored in the storage unit, it is highly likely that data was corrupted during data communication. It is conceivable that various factors such as a failure in a transmission source device and a connection failure in a connector or the like of a communication line can cause data corruption. Thus, by recording an error log, the cause of the failure can be determined, and necessary measures can be taken.

In the control apparatus according to the present embodiment, if the data identifier received by the receiving unit is not included in the associated information stored in the storage unit, the control unit notifies a central control apparatus that a designator has not been determined.

If a data identifier received by the receiving unit is not included in the associated information stored in the storage unit, the control unit notifies the central control apparatus that a designator has not been determined. The central control apparatus can be an upper-level control apparatus that manages each control apparatus. Accordingly, the central control apparatus can determine whether or not each control apparatus was able to determine a function or operation.

In the control apparatus according to the present embodiment, the control unit notifies the central control apparatus of the determined designator.

The control unit notifies the central control apparatus of the determined designator. Accordingly, the central control apparatus can determine whether or not each control apparatus was able to determine a function or operation.

In the control system of the present embodiment, the central control apparatus includes a storage unit that stores information regarding whether or not the designator of each control apparatus has been determined, and a control unit, and if the central control apparatus receives a notification indicating that the designator of one control apparatus has not been determined, the control unit determines the designator of the one control apparatus based on information stored in the storage unit and notifies the one control apparatus of the thus determined designator.

The central control apparatus includes: a storage unit configured to store information regarding whether or not a designator has been determined for each of the plurality of control apparatuses; and a control unit, wherein, if the central control apparatus receives a notification indicating that the designator of one control apparatus has not been determined, the control unit determines the designator of the one control apparatus based on the information stored in the storage unit, and notifies the one control apparatus of the determined designator.

For example, assuming four control apparatuses are installed in a vehicle, the function or operation of each control apparatus is indicated as A, B, C, or D, and the designators that designate the functions or operations A, B, C, and D are indicated as AAA, BBB, CCC, or DDD. It is assumed that three of the four control apparatuses have made a notification indicating that designators have been determined as BBB, CCC, and DDD, and a notification indicating that a designator has not been determined has been received from the remaining one control apparatus. The central control apparatus determines that the designator of the control apparatus whose designator has not been determined is AAA (excluding BBB, CCC, and DDD), and notifies the control apparatus of the designator. Accordingly, even if there is a control apparatus that cannot determine a designator for the same, the designator therefor can be determined by the central control apparatus.

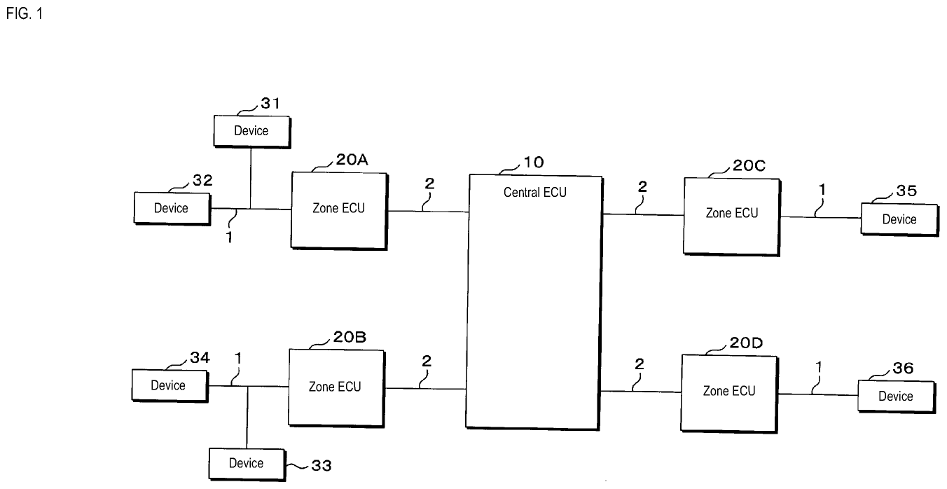

An embodiment of the present disclosure will be described below with reference to the drawings. FIG. 1 is a schematic drawing showing an example of a configuration of a control system of the present embodiment. The control system includes a central ECU 10 serving as a central control apparatus, and zone ECUs 20A, 20B, 20C, and 20D each serving as a control apparatus. The zone ECUs 20A, 20B, 20C, and 20D are also collectively referred to as a zone ECU 20. The central ECU 10 can be an upper-level ECU that manages each zone ECU 20. While a configuration comprising four zone ECUs is shown in FIG. 1, it is sufficient that there is more than one zone ECU, and the number of zone ECUs is not limited to four. The central ECU 10 is connected to the zone ECUs 20A, 20B, 20C, and 20D by communication lines 2, respectively. For example, Ethernet (registered trademark) can be used for each communication line 2, but the present disclosure is not limited to this.

The zone ECUs 20A, 20B, 20C, and 20D perform, in addition to shared functions or operations, different functions or operations according to the placement of corresponding control targets in the vehicle (for example, front, rear, left, and right sides of vehicle). For example, the zone ECU 20A can communicate with devices 31 and 32 via a communication line 1, the zone ECU 20B can communicate with devices 33 and 34 via a communication line 1, the zone ECU 20C can communicate with a device 35 via a communication line 1, and the zone ECU 20D can communicate with a device 36 via a communication line 1. A CAN (Controller Area Network) can be used for the communication lines 1, but the present disclosure is not limited to this.

The devices 31 to 36 include, for example, an actuator, a sensor, a switch, an ECU (Electronic Control Unit), and the like. The zone ECUs 20A, 20B, 20C, and 20D can be referred to as ECUs that consolidate various functions.

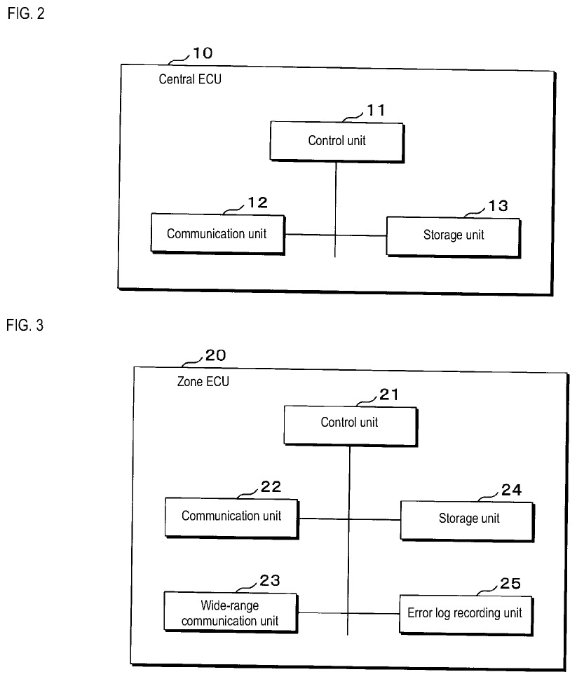

FIG. 2 is a block diagram showing an example of a configuration of the central ECU 10. The central ECU 10 includes a control unit 11, a communication unit 12, and a storage unit 13. The control unit 11 can be constituted by a CPU, a ROM, a RAM, or the like, and controls the overall central ECU 10.

The communication unit 12 has the function of communicating with each of the zone ECUs 20A, 20B, 20C, and 20D using communication protocol determined for each communication line 2.

The storage unit 13 can be constituted by, for example, a semiconductor memory or the like, and can store information received from each of the zone ECUs 20A, 20B, 20C, and 20D. Also, the storage unit 13 can store information that is to be transmitted to each of the zone ECUs 20A, 20B, 20C, and 20D. The storage unit 13 can store information regarding whether or not each of the zone ECUs 20A, 20B, 20C, and 20D has determined a designator. The designators are for designating the function or operation of each of the zone ECUs 20A, 20B, 20C, and 20D.

If, as described below, the central ECU 10 receives a notification indicating that one zone ECU has not determined a designator, the control unit 11 can determine the designator of the one zone ECU based on information stored in the storage unit 13. A designator not being determined can also be considered as a mounting position not being allocated. The method for determining a designator is described in detail below.

The control unit 11 can notify the one zone ECU (the zone ECU that made a notification indicating that no designator has been determined) of a determined designator. Also, if there is a zone ECU that has not determined a designator, the control unit 11 can output a warning that an abnormality has occurred. The warning output may be output via a display or output using audio.

FIG. 3 is a block diagram showing an example of a configuration of the zone ECU 20. The zone ECU 20 includes a control unit 21, a communication unit 22, a wide-range communication unit 23, a storage unit 24, and an error log recording unit 25. The control unit 21 can be constituted by a CPU, a ROM, a RAM, or the like, and controls the overall zone ECU 20.

The communication unit 22 has a function of communicating with a device (any of devices 31 to 36) connected to the zone ECU using communication protocol determined for the communication line 1. The communication unit 22 functions as a receiving unit, and can receive a data identifier from a device (transmission source device) via the communication line 1. The data identifier identifies the source device that transmitted data, and CAN-ID can be used if the communication protocol is CAN, for example. Also, the communication unit 22 has the function of communicating with the central ECU 10 using the communication protocol determined for the communication line 2.

The wide-range communication unit 23 can transmit/receive data to/from an external server (associated information providing apparatus, program providing apparatus) via the Internet, a phone line, or the like.

The storage unit 24 can be constituted by, for example, a semiconductor memory or the like, and can store associated information. The associated information will be described in detail below.

The control unit 21 can determine the designator of a zone ECU based on a data identifier received by the communication unit 22 and associated information stored in the storage unit 24. The method for determining the designator is described in detail below.

The control unit 21 can update the associated information stored in the storage unit 24 using associated information obtained from an external server.

The error log recording unit 25 functions as a recording unit, and if a data identifier received by the communication unit 22 is not included in the associated information stored in the storage unit 24, the error log recording unit 25 can record the data identifier as an error log.

Next, the associated information will be described.

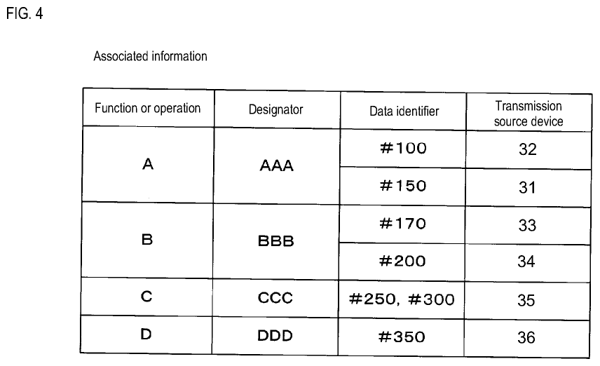

FIG. 4 is a schematic diagram showing an example of associated information. The associated information is information in which a designator that designates the function or operation of a zone ECU and a data identifier that identifies the transmission source device that transmits data to the zone ECU are associated with each other for each of a plurality of designators. As shown in FIG. 4, the associated information can be constituted by the items: function or operation; designator; data identifier; and transmission source device.

In the manufacturing stage or the assembly stage of the vehicle, the same associated information is stored in the storage unit 24 of each zone ECU mounted to the vehicle. For example, it is assumed that four zone ECUs are installed in the vehicle, different functions or operations of each of the four zone ECUs are indicated as A, B, C, or D according to in-vehicle mounting positions or the like, and the designators that designate the functions or operations A, B, C, and D are indicated as AAA, BBB, CCC, or DDD.

It is assumed that the zone ECU whose function or operation is A receives the data identifier #100 from the transmission source device 32, and receives the data identifier #150 from the transmission source device 31. A function or operation (that is, a designator) of a zone ECU and a device that transmits/receives data can be associated with each other in advance based on positions where the zone ECUs and the transmission source devices are mounted in the vehicle. Similarly, it is assumed that the zone ECU whose function or operation is B receives the data identifier #170 from the transmission source device 33, and receives the data identifier #200 from the transmission source device 34. It is assumed that the zone ECU whose function or operation is C receives the data identifiers #250 and #300 from the transmission source device 35, and the zone ECU whose function or operation is D receives the data ID #350 from the transmission source device 36.

In the manufacturing stage or the assembly stage of the vehicle, the zone ECUs mounted in the vehicle are manufactured with the same part number and thus are used in common. In other words, at the point in time in which each zone ECU is installed to the vehicle, no determination is made as to whether the ECUs themselves are to perform either a function or operation.

Next, the method for determining the function or operation of each zone ECU 20 will be described.

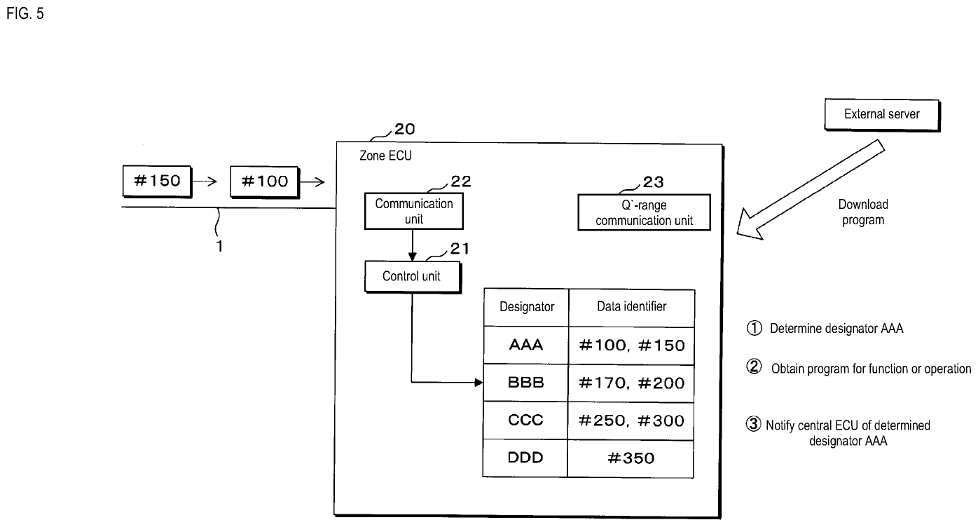

FIG. 5 is a schematic diagram showing an example of a method for determining a function or operation of the zone ECU 20. In a state where the zone ECUs and the devices have been installed in the vehicle and connected to each other via communication lines (manufacturing stage or assembly stage), each device can periodically transmit data to a zone ECU following a pre-determined procedure in response to a system being turned on and initiating operation, for example.

The communication unit 22 receives a data identifier from a transmission source device via the communication line 1. In the manufacturing stage or the assembly stage in which common-use control apparatuses are installed in the vehicle, the initiation of data transmission from each transmission source device results in the communication unit 22 being able to receive a data identifier. In the example shown in FIG. 5, the data identifiers are #100 and #150.

The control unit 21 determines the designator of the zone ECU 20 based on the data identifiers received by the communication unit 22 and the associated information stored in the storage unit 24. In the example shown in FIG. 5, it can be understood that the designator that corresponds to the received data identifiers #100 and #150 is the designator AAA, and thus the function or operation of the zone ECU 20 can be determined as being the function or operation A. The other zone ECUs can also determine a designator in a similar fashion, and also determine the function or operation thereof. In this way, the function or operation of each zone ECU can be determined automatically, and a manual operation performed by manufacturing staff or the like is also unnecessary.

That is, in the manufacturing stage or the assembly stage where standardized, general-purpose zone ECUs are installed in the vehicle, the function or operation of each zone ECU in the vehicle can be determined. Accordingly, standardized, general-purpose zone ECUs can be manufactured, and the function or operation of each zone ECU can be determined in the manufacturing stage or the assembly stage of the vehicle, and thus there is no need to individually manufacture ECUs with different functions or operations in advance, and the manufacturing cost can be reduced.

The control unit 21 outputs the determined designator to an external server serving as the program providing apparatus via the wide-range communication unit 23. The external server can, for example, change each standardized, general-purpose zone ECU to a zone ECU dedicated to a certain function or operation by installing a program corresponding to that certain function or operation in the corresponding standardized, general-purpose zone ECU.

The control unit 21 can obtain a program for realizing the function or operation designated by the designator from the external server, via the wide-range communication unit 23. By installing the obtained program, the zone ECU 20 can realize the function or operation designated by the designator. In other words, in the manufacturing stage or the assembly stage of the vehicle, the standardized, general-purpose zone ECUs 20 can be changed to a zone ECU 20 dedicated to a certain function or operation. Note that obtaining a program includes, in addition to obtaining a complete or partial program, obtaining parameters read by a program (for example, a configuration file) of the zone ECU 20.

The control unit 21 can execute processing that is based on the program obtained from the external server. Accordingly, each zone ECU 20 installed in the vehicle can execute not only shared functions or operations, but also unique functions or operations that correspond to mounting positions in the vehicle, for example. Note that a program is not limited to being obtained from an external server. For example, a configuration may be employed where programs for realizing different functions and operations of each zone ECU are stored in the central ECU 10 in advance, and the programs are obtained from the central ECU 10.

The control unit 21 can make a notification to the central ECU 10 regarding the determined designator via the communication unit 22. Accordingly, the central ECU 10 can determine whether or not each zone ECU 20 was able to determine a function or operation.

Next, a case where a zone ECU 20 is unable to determine a function or operation will be described.

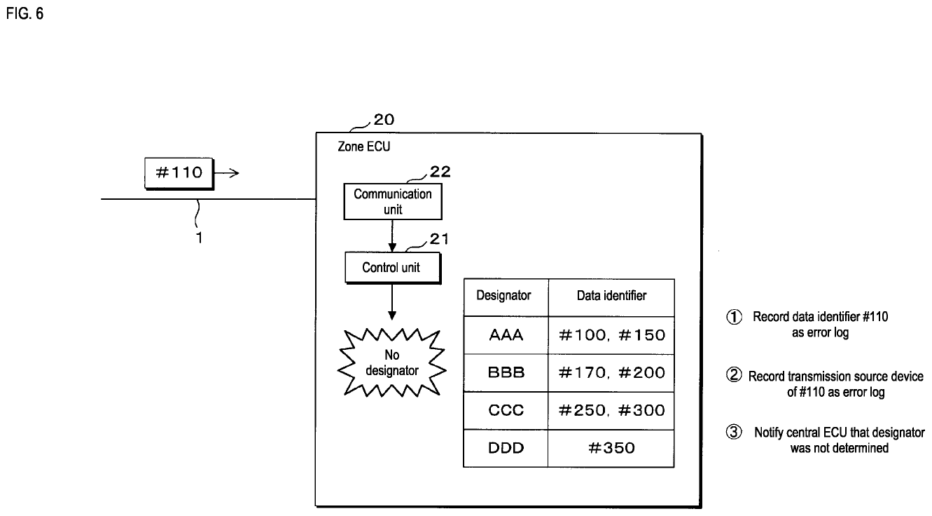

FIG. 6 is a schematic diagram showing an example of processing performed when the zone ECU 20 cannot determine a function or operation. If a data identifier received by the communication unit 22 is not included in the associated information stored in the storage unit 24, the error log recording unit 25 can record the data identifier as an error log. In the example shown in FIG. 6, the communication unit 22 receives the data identifier #110, but there is no designator that corresponds to the data identifier #110. The transmission source device of the data identifier can also be recorded as an error log. For example, in the example shown in FIG. 4, if the data identifier #100 is received and the data identifier #110 is received in place of the data identifier #150, the device 31 can be recorded as an error log. If a received data identifier is not included the associated information stored in the storage unit 24, it is highly likely that data was corrupted during data communication. It is conceivable that various factors such as a failure in a transmission source device and a connection failure in a connector or the like of a communication line can cause data corruption. Thus, by recording an error log, the cause of the failure can be determined, and necessary measures can be taken.

If a data identifier received via the communication unit 22 is not included in the associated information stored in the storage unit 24, the control unit 21 can make a notification indicating that a designator has not been determined to the central ECU 10. Accordingly, the central ECU 10 can determine whether or not each zone ECU 20 was able to determine a function or operation.

Next, the method for determining a function or operation of the zone ECU 20 performed by the central ECU 10 will be described.

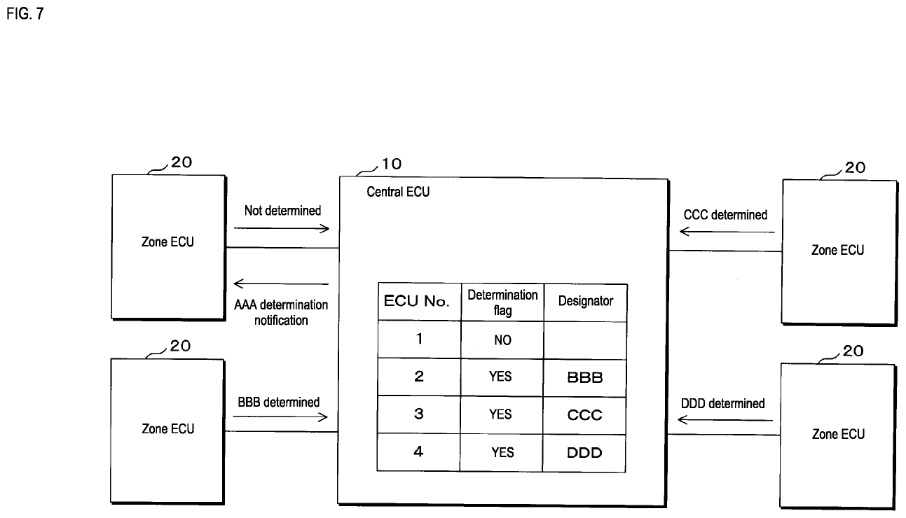

FIG. 7 is a schematic diagram showing an example of a method for determining a function or operation of the zone ECU 20 performed by the central ECU 10. The storage unit 13 of the central ECU 10 can store information regarding whether or not each zone ECU 20 has determined a designator. As shown in FIG. 7, it is assumed that four zone ECUs 20 are installed in the vehicle, the function or operation of each of the four zone ECUs 20 is indicated as A, B, C, or D, and the designators that designate the functions or operations A, B, C, and D are indicated as AAA, BBB, CCC, or DDD. It is assumed that three of the four zone ECUs 20 have made notifications indicating that the designators have been determined as being BBB, CCC, and DDD, and a notification indicating that a designator has not been determined has been received from the remaining one zone ECU 20. The central ECU 10 determines that the designator of the zone ECU 20 whose designator has not been determined is AAA (excluding BBB, CCC, and DDD), and notifies the zone ECU 20 of the designator. Accordingly, even if there is a zone ECU 20 that cannot determine a designator, the designator therefor can be determined by the central ECU 10.

Next, a method for updating associated information will be described.

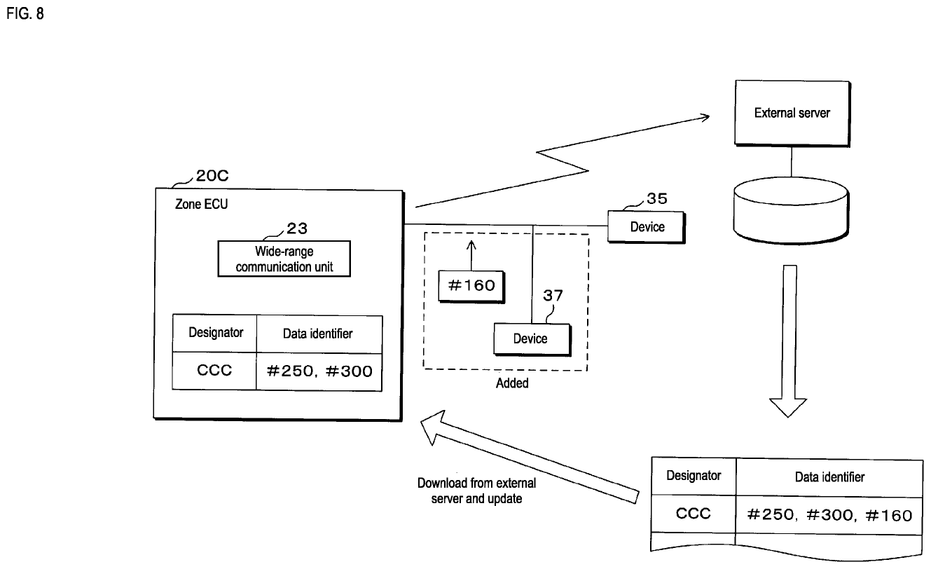

FIG. 8 is a schematic diagram showing an example of a method for updating associated information. As shown in FIG. 8, it is assumed that a new device 37 has been added as an option or through customization and that the device 37 has transmitted the data identifier #160. In this case, the zone ECU 20C receives the data identifier #160 that is not included in the associated information (associated information between designator CCC and data identifiers #250 and #300). In this case, the control unit 21 can obtain the most recent associated information from an external server serving as the associated information providing apparatus, via the wide-range communication unit 23. The control unit 21 updates the associated information stored in the storage unit 24 using the associated information thus obtained from the external server.

In this way, in the case where each zone ECU 20 is installed in the vehicle, and a new transmission source device (also including ECUs) is added as an option or through customization, there are cases where information regarding the newly added transmission source device is not included in the associated information stored in the storage units 24. In such a case, by updating the associated information, the associated information can be updated to the most recent information. If a data identifier that is not included in the associated information is received despite performing an update, the data identifier may be reported as an abnormality.

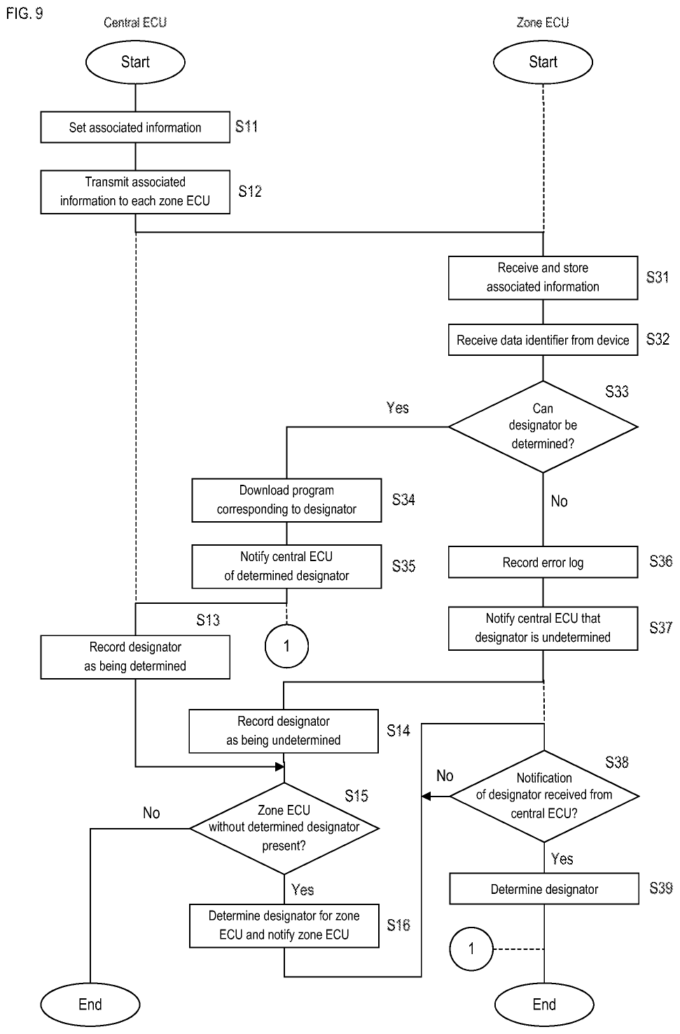

FIG. 9 is a flow chart showing an example of a processing procedure performed by a control system of the present embodiment. The central ECU 10 sets associated information (step S11). Associated information can be set as instructed by an operator in the manufacturing stage or the assembly stage. The central ECU 10 transmits associated information to each zone ECU 20 (step S12).

The zone ECU 20 receives and stores associated information (step S31). The ECU 20 receives a data identifier from a device (transmission source device) (step S32), and determines whether or not a designator for the zone ECU can be determined (step S33). If the designator can be determined (YES in step S33), the zone ECU 20 downloads the program corresponding to the thus determined designator (step S34), and makes a notification regarding the determined designator to the central ECU 10 (step S35), and terminates the processing. The central ECU 10 performs the processing of step S13 described below.

If a designator cannot be determined (NO in step S33), the zone ECU 20 records an error log (step S36) and notifies the central ECU 10 that no designator has been determined (step S37), and the central ECU 10 performs the processing of step S14 described below.

The central ECU 10 records the designator as having been determined (step S13), and performs the processing of step S15 described below. Also, the central ECU 10 records the designator as not having been determined (step S14), and determines whether or not there is a zone ECU 20 whose designator has been not been determined (step S15). If there is a zone ECU 20 whose designator has not been determined (YES in step S15), the central ECU 10 determines the designator of the zone ECU without a determined designator, notifies the zone ECU 20 of the determined designator (step S16), and the zone ECU 20 performs the processing of step S38 described below. If there are no zone ECUs 20 whose designator has not been determined (NO in step S15), the central ECU 10 terminates the processing.

The zone ECU 20 determines whether or not a notification regarding a designator has been received from the central ECU 10 (step S38), and if no notification has been received (NO in step S38), the zone ECU 20 continues the processing of step S38. If a notification has been received (YES in step S38), the zone ECU 20 determines the designator (step S39), and terminates the processing.

In the present embodiment, each zone ECU can also function as a power distributor. For example, power from a battery can be supplied to a device via a zone ECU.

The embodiments disclosed herein are exemplary in all respects, and should be construed as not being restrictive. The scope of the present disclosure is indicated by the claims rather than the above description, and all changes and amendments that come within the meaning and range of equivalency of the claims are intended to be embraced therein.

1. A control apparatus comprising:
a storage unit configured to store associated information in which a designator that designates a function or operation of a control apparatus and a data identifier that identifies a transmission source device that is a transmission source of data are associated with each other for each of a plurality of designators;
a receiving unit configured to receive the data identifier from the transmission source device via a communication line; and
a control unit,
wherein the control unit determines a designator for the control apparatus based on the data identifier received by the receiving unit and the associated information.

2. The control apparatus according to claim 1, wherein the control unit refers to the associated information stored in the storage unit based on the data identifier received by the receiving unit, and determines, as the designator for the control apparatus, a designator associated with a data identifier that matches the received data identifier.

3. The control apparatus according to claim 1, wherein the control unit outputs the determined designator to a program providing apparatus, and
obtains a program for realizing a function or operation designated by the designator from the program providing apparatus.

4. The control apparatus according to claim 3, wherein the control unit executes processing that is based on the obtained program.

5. The control apparatus according to claim 1, wherein, if the data identifier received by the receiving unit is not included in the associated information, the control unit obtains associated information from an associated information providing apparatus, and
updates the associated information stored in the storage unit using the obtained associated information.

6. The control apparatus according to claim 1, comprising:
a recording unit configured to, if the data identifier received by the receiving unit is not included in the associated information stored in the storage unit, record the data identifier as an error log.

7. The control apparatus according to claim 1, wherein, if the data identifier received by the receiving unit is not included in the associated information stored in the storage unit, the control unit notifies a central control apparatus that a designator has not been determined.

8. The control apparatus according to claim 7, wherein the control unit notifies the central control apparatus of the determined designator.

9. A control system comprising:
a plurality of control apparatuses according to claim 1 that perform different functions or operations; and
a central control apparatus that is connected to the plurality of control apparatuses via communication lines.

10. The control system according to claim 9,
wherein the central control apparatus includes:
a storage unit configured to store information regarding whether or not a designator has been determined for each of the plurality of control apparatuses; and
a control unit,
wherein, if the central control apparatus receives a notification indicating that the designator of one control apparatus has not been determined, the control unit determines the designator of the one control apparatus based on the information stored in the storage unit, and
notifies the one control apparatus of the determined designator.

11. A method for determining a function or operation of a control apparatus, the method comprising:
storing associated information in which a designator that designates a function or operation of a control apparatus and a data identifier that identifies a transmission source device of data are associated with each other for each of a plurality of designators;
receiving the data identifier from the transmission source device via a communication line; and
determining a designator based on the received data identifier and the associated information.
